(19) United States
(12) Patent Application Publication
(10) Pub. No.: US 2002/0077092 A1
(43) Pub. Date: Jun. 20, 2002

(54) Method for setting up a diversion at a communication terminal

(76) Inventor: Hans-Peter Von Ow, Muenchen (DE)

Correspondence Address: BELL, BOYD & LLOYD, LLC, P. O. BOX 1135, CHICAGO, IL, 60690-1135, US

(21) Appl. No.: 09/951,648

(22) Filed: Sep. 13, 2001

(30) Foreign Application Priority Data
Sep. 13, 2000 (DE) 100 45 246.9

(51) Int. Cl. H04M 3/42

(52) U.S. Cl. 455/417; 455/435

(57) ABSTRACT

A method for setting up a diversion at a communication terminal which is temporarily allocated to a mobile subscriber of a communication system via registration, wherein at least one input element is reserved at this communication terminal, on selection of which input element a diversion to a diversion destination terminal noted as available for the respective mobile subscriber is initiated by the communication system and, following this, calls to the mobile subscriber are diverted to the diversion destination terminal.

### BACKGROUND OF THE INVENTION

In many communication systems, especially in communication systems of businesses, a function is provided which is intended to enable persons, who frequently change their local place of work, to designate any communication terminal (simply called “terminal” in the text which follows) individually as their own. Such subscribers are called “mobile subscribers” for whom all subscriber data such as directory number, authorizations, destination numbers, etc., are stored as subscriber record in the communication system, but they are not physically allocated a “fixed terminal”. For this reason, a mobile subscriber is recorded as “fictitious subscriber” in the communication system and the subscriber record associated with this subscriber is called “home station”.

A mobile subscriber can allocate oneself to any terminal within a communication network by registering. During the registration, the mobile subscriber authorizes oneself via his/her directory number in the network and a personal identification number (“PIN”). Incidentally, instead of a PIN input, many terminals also support identification via a chip card.

After authorization has taken place, the communication system directs calls arriving for the mobile subscriber to the relevant terminal. In addition, the treatment of this terminal is configured via the subscriber data in the home station of the mobile subscriber; among other things, the name of the mobile subscriber is output as the name of the calling party in the case of outgoing calls and authorization data of the mobile subscriber are also loaded.

If the allocation of a terminal to a mobile subscriber is released, for example after the mobile subscriber has signed off, a so-called “fixed call diversion”, the destination of which is generally a central answering machine (“voice mail”) of the communication system, is activated for calls directed to the mobile subscriber. Fixed call diversion is understood to be a diversion to a preset destination if no allocation to another terminal is set up. The information identifying this destination is also a component of the data of the fictitious subscriber which is stored in the home station of the mobile subscriber.

If a mobile subscriber wishes to change from one terminal to another one, he/she must first sign off at the current terminal and calls arriving for the mobile subscriber are then directed to the central answering machine as mentioned above. After signing off, the mobile subscriber can register again at another terminal which, after completed registration, is then configured with his/her subscriber data in the home station. As an alternative, a mobile subscriber can initiate a call diversion to another terminal if he/she wants to receive incoming calls without registering at this terminal. To initiate this diversion, the subscriber must select, at the terminal at which he/she is registered, a feature “Program diversion at a third subscriber” and input the directory number of his/her home station, his/her personal identification number and the directory number of the terminal to which the diversion is to take place.

It is an object of the present invention to simplify the call diversion of a mobile subscriber.

### SUMMARY OF THE INVENTION

Accordingly, in an embodiment of the present invention, a method is provided for setting up a diversion at a communication terminal which is temporarily allocated to a mobile subscriber of a communication system via registration, wherein the method includes the steps of: reserving at least one input element at the communication terminal; initiating a diversion, via the communication system upon selection of the at least one input element, to a diversion destination terminal noted as available for the mobile subscriber; and diverting calls to the mobile subscriber, via the communication system, to the diversion destination terminal.

In the method according to the present invention, the mobile subscriber does not need to input the directory number of his/her home station and his/her personal identification number since these data are known from the authorization of the mobile subscriber and are used again for the present method.

A significant advantage of the method according to the present invention is that a diversion of the mobile subscriber is managed simply by selecting an input element on a terminal at which the subscriber is currently registered.

A further advantage of the method according to the present invention lies in the fact that its implementation only requires minimum interventions in network protocols or, respectively, in the network structure and can be implemented only by changes in the control program of the communication system of the home station.

Advantageously, name keys already existing on the terminal are reserved for rendering a required diversion destination rapidly selectable in the sense of the present invention, and the name key also can be configured as an area of a touch-sensitive screen. If the terminal has a voice input device, the diversion destination is selected by a spoken word.

Using a processing code which is allocated to a reserved input element allows the call diversion to be processed by the system control of the communication system associated with the home station of the mobile subscriber, which does not require any far-reaching changes in the program sequence. The processing code is transferred to the program control, without checks by network protocols, and used by the program control for selecting the diversion destination. The system control of the communication system associated with the home station of the mobile subscriber, with the aid of the processing code, initiates a selection from diversion destinations stored in the subscriber data of the mobile subscriber.

If a mobile subscriber has registered at a terminal of a communication system which is not identical with the communication system of his/her associated home station, the processing code is advantageously transferred from the communication system of the terminal to the communication system of the home station in order not to restrict the initiation of a diversion by the mobile subscriber to terminals which are only allocated to the communication system of his/her home station.

A write protection has the advantage of preventing unintentional changing or deletion of the processing code by a subscriber. This also suitably prevents an intended change since the processing code can only be interpreted by the system control of the communication system allocated to the home station of the mobile subscriber, but not by the subscriber. In particular, the processing code does not contain any information on the directory number of the diversion destination which is only carried out by a directory number allocation in the communication system associated with the home station of the mobile subscriber.

A further development of the present invention provides that a subscriber who has signed off at a terminal, when selecting one of the reserved input elements, receives a message which points out that this feature is not available to him/her. This also has the advantage that an unregistered subscriber who operates the terminal after a mobile subscriber has signed off is informed of the non-admissibility of the selection of this reserved input element.

Additional features and advantages of the present invention are described in, and will be apparent from, the following Detailed Description of the Invention and the Figures.

### BRIEF DESCRIPTION OF THE FIGURES

FIG. 1 diagrammatically shows the systems and messages involved in the diversion of a mobile subscriber.

FIG. 2 diagrammatically shows the configuration of the processing code of the reserved input elements.

### DETAILED DESCRIPTION OF THE INVENTION

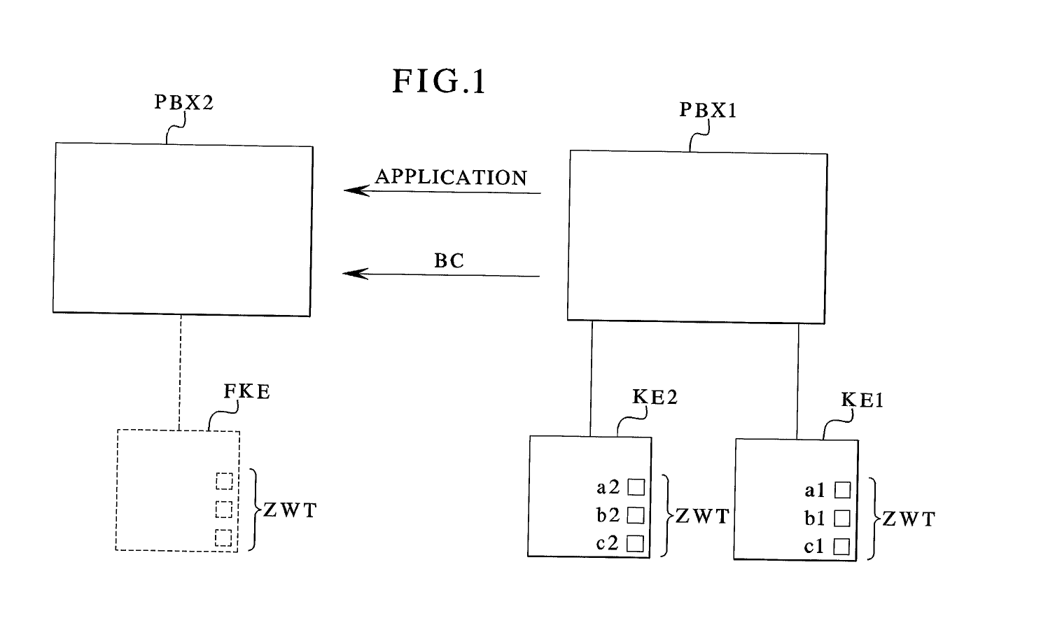

FIG. 1 shows a first communication system PBX1 with a first and a second connected terminal KE1 and KE2, respectively. In addition, a fictitious terminal FKE belonging to another communication system PBX2 is shown. This fictitious terminal FKE is a symbolic representation of the home station—that is to say the location of the subscriber data of the associated fictitious subscriber—of a mobile subscriber who has registered, for example, at the first terminal KE1.

The fictitious terminal FKE is shown dashed in order to indicate that this is not a real device but a representation of the home station which symbolizes the function, the functions of which are performed by the second communication system PBX2.

In the present case it will be assumed that a mobile subscriber registers via the first terminal KE1, the associated communication system PBX1 of which is not identical with the communication system PBX2 of the home station of the mobile subscriber. The data related to a registration of the mobile subscriber are transferred—as shown by an arrow—from the first communication system PBX1 to the second communication system PBX2.

In the first and second terminal KE1, KE2, reserved name keys ZWT are in each case provided, from which a registered mobile subscriber can select, i.e. operate, one of the name keys ZWT in order to initiate a diversion to another terminal. At the mobile terminal FKE, name keys ZWT are also shown which, however, are only intended to serve as functional symbolization of the name keys ZWT at the home station.

The name keys ZWT a1, b1, c1 have been reserved in the first and second terminal KE1, KE2 for the diversion of a mobile subscriber by allocating to them a respective processing code BC. The mobile subscriber who has registered at the first terminal KE1 can, thus, initiate a diversion to another terminal, e.g. the second terminal KE2, by pressing the name key ZWT a1 designating this destination and thus triggering the output of a processing code identifying this destination. When the name key ZWT a1 is operated, an associated processing code BC is thus transferred to the second communication system PBX2 containing the home station of the mobile subscriber. After the mobile subscriber has signed off from his/her current terminal KE1, the diversion to the second terminal KE2 is then initiated.

Although the processing code BC transferred to the second communication system PBX2 differs in dependence on the reserved name key ZWT pressed, it does not depend on the respective mobile subscriber who is registered at the terminal KE1 since the processing code BC only identifies the pressed name key (e.g., name key ZWT a1), but the diversion destination allocated to this name key is allocated in dependence on the respective mobile subscriber from his/her subscriber data.

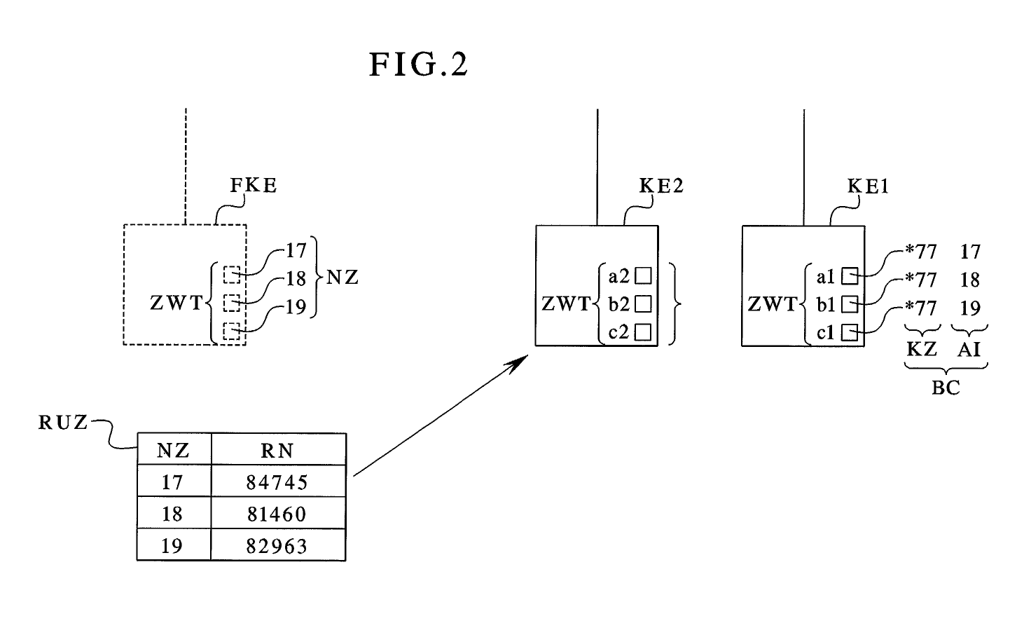

FIG. 2 shows the components of the processing code BC, by way of example, during the diversion of a mobile subscriber. In this connection, only the first and second terminal KE1, KE2 and the fictitious terminal FKE are shown, without their associated communication systems.

At the first terminal KE1, the allocation of the reserved name keys ZWT a1, b1, c1 to their respective processing code BC is shown. The respective processing code BC contains an identification number KZ and an address information item AI. The identification number KZ (*77) selects a subroutine, which controls the further processing of the diversion, which can be activated via this identification number KZ within the program structure in the second communication system PBX2 (not shown) belonging to the home station of the mobile subscriber.

The second component of the processing code BC, the address information item AI, is used by this subroutine for determining the diversion destination. The address information item AI is used for selecting the directory number RN of the terminal to which a diversion is to be initiated. In the text which follows, the processes during a diversion of a mobile subscriber are explained via a diversion from the first terminal KE1 to the second terminal KE2.

If a reserved name key ZWT a1 is selected, i.e. operated, at the first terminal KE1, the processing code BC (*7717) belonging to this name key ZWT a1 is transferred from the first communication system PBX1 (not shown), which is associated with this first terminal KE1, to the second communication system PBX2 (not shown) because a check in the allocation tables of the first communication system PBX1 (not shown) has shown that the home station of the mobile subscriber is located in the second communication system PBX2 (not shown). Each of the name keys ZWT a1, b1, c1 which are reserved at the first terminal KE1 for the diversion of a mobile subscriber has been permanently allocated a respective processing code BC; i.e., a subscriber who has not registered as a mobile subscriber at this terminal KE1 can also operate these reserve name keys and initiate the delivery of a processing code to the first communication system PBX1. For this reason, a check is first made in the first communication system PBX1 as to whether a mobile subscriber has registered at the first terminal KE1 because a diversion can only be initiated by these reserve name keys ZWT a1, b1, c1 for a mobile subscriber. For a non-registered subscriber, in contrast, the first communication system PBX1, as a consequence of one of the three reserve name keys ZWT a1, a2 or a3 being operated, initiates a message pointing out that this feature is not available at an output unit of the terminal KE1.

For processing the call diversion of the mobile subscriber, it is known due to the authorization of the mobile subscriber that the station to be diverted is the home station of the subscriber which is located in another communication system; in this case, the second communication system PBX2. To determine the diversion destination, the processing code BC is interpreted.

With regard to the program implementation, selecting the name key ZWT a1 with the processing code BC “*7717” selects in the program structure of the communication system PBX2 (not shown) a subroutine reserved for the identification number KZ “*77” which compares the address information item AI (“17”) with name destinations NZ of the fictitious terminal. To represent them pictorially, these name destinations NZ are shown as name keys ZWT of the fictitious terminal FKE. The name destinations NZ are used by the system control of the communication system PBX2 (not shown) for selecting the directory number RN of a subscriber in a directory number allocation table RUZ.

The directory number RN (“84745”) allocated to the name destination NZ (“17”) corresponds to the directory number of the second terminal KE2 to which a diversion of the mobile subscriber is initiated after he/she has signed off from the first terminal KE1. For this purpose, the aforementioned subroutine calls up the feature “Program diversion at a third subscriber” which is already present for “variable call diversions” in the system control of the communication system PBX2 (not shown).

A variable call diversion is understood to be the diversion to a diversion destination wherein this diversion, in distinction from a “fixed call diversion”, does not select a preset diversion destination but performs a call diversion to a diversion destination to be specified during the diversion activity. As the specified diversion destination, the directory number RN of the second terminal KE2 to which the diversion is performed after the mobile subscriber has signed off at the first terminal KE1, is determined with the aid of the directory number allocation table RUZ.

Although the present invention has been described with reference to specific embodiments, those of skill in the art will recognize that changes may be made thereto without departing from the spirit and scope of the invention as set forth in the hereafter appended claims.

1. A method for setting up a diversion at a communication terminal which is temporarily allocated to a mobile subscriber of a communication system via registration, the method comprising the steps of:
reserving at least one input element at the communication terminal;
initiating a diversion, via the communication system upon selection of the at least one input element, to a diversion destination terminal noted as available for the mobile subscriber; and
diverting calls to the mobile subscriber, via the communication system, to the diversion destination terminal.

2. A method for setting up a diversion at a communication terminal as claimed in claim 1, wherein the at least one input element is a name key of the communication terminal.

3. A method for setting up a diversion at a communication terminal as claimed in claim 1, wherein the at least one input element is a spoken word for a voice input device of the communication terminal.

4. A method for setting up a diversion at a communication terminal as claimed in claim 1, wherein, upon the selection of the at least one input element, delivery of a processing code, for controlling the diversion, to a system control module of the communication system is initiated.

5. A method for setting up a diversion at a communication terminal as claimed in claim 4, wherein a further communication system is connected to the communication system, in which further communication system subscriber data of the mobile subscriber are stored, and the processing code is transferred to the further communication system.

6. A method for setting up a diversion at a communication terminal as claimed in claim 4, wherein the mobile subscriber is prevented from changing the processing code.

7. A method for setting up a diversion at a communication terminal as claimed in claim 1, the method further comprising the step of:
outputting a rejection message at the communication terminal upon selection of the reserved input element after a signing-off by the mobile subscriber.
